(19) United States
(12) Patent Application Publication
(10) Pub. No.: US 2006/0087288 A1
(43) Pub. Date: Apr. 27, 2006

(54) Battery charger

(76) Inventor: Jung-Hua Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/972,460

(22) Filed: Oct. 26, 2004

(51) Int. Cl. H02J 7/00

(52) U.S. Cl. 320/128

(57) ABSTRACT

A battery charger includes a main body and a switch circuitry deposited in the main body. The switch circuitry circuit transforms alternating or direct current input into a desired direct current output with a pair of switches protruding from the main body to control the output into different voltage and current values for different electronic appliances.

### BACKGROUND OF THE INVENTION

1. Field of the Invention

This invention relates to a battery charger, and more particularly to a battery charger applied to different electronic appliances with two switches to adjust different output voltage and current values.

2. Description of the Prior Art

Electronic appliances have been widely used by families and individuals. Some appliances use alternating current, while the others use direct current. In particular to those portable electronic items, each appliance has different current and voltage requirement. Thus, a user needs to prepare different battery chargers. It is very inconvenient for a user to take along.

### SUMMARY OF THE INVENTION

It is the primary objective of the present invention to provide a battery charger, which outputs various voltage and current values for different electronic appliances.

It is another objective of the present invention to provide a battery charger, which is easy to operate.

It is a further objective of the present invention to provide a battery charger, which is cost effectiveness.

### BRIEF DESCRIPTION OF THE DRAWINGS

FIG. 1 is an explosive view of the present invention;

FIG. 2 is a circuitry diagram of the present invention;

FIG. 3 is a top view of the present invention;

FIG. 4 is a perspective view of a second embodiment of the present invention, and

FIG. 5 is a circuitry diagram of the second embodiment of the present invention.

### DETAILED DESCRIPTION OF THE PREFERRED EMBODIMENT

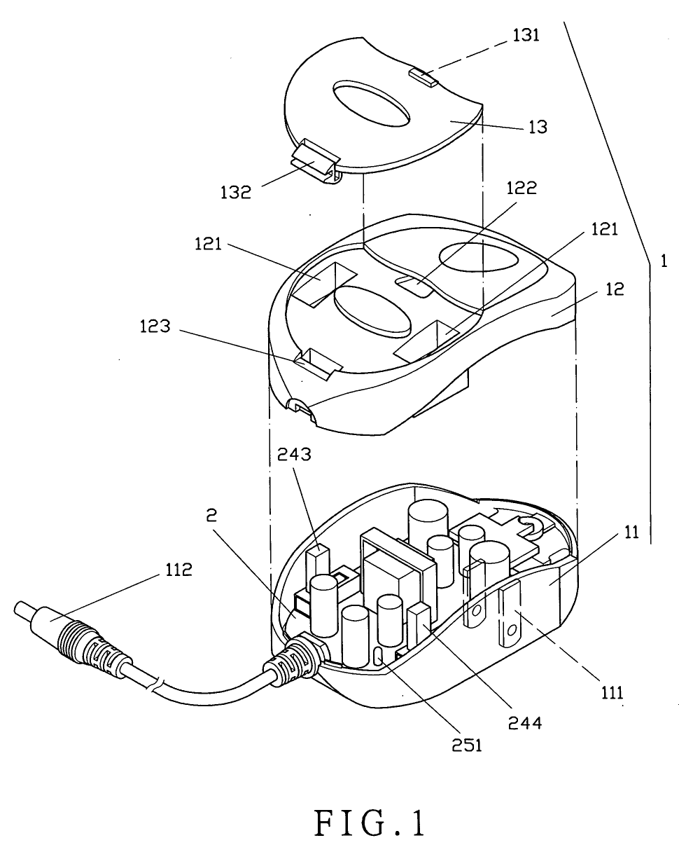

As shown in FIG. 1, the present invention comprises a main body 1 and a switch circuitry 2. In the preferred embodiment, alternating current (AC) transformed into direct current (DC) will be applied.

The main body 1 comprises a base 11 adapted to secure the switch circuitry 2 therein, a cover 12, and a lid 13. The base 11 comprises a pair of plugs 11 at the bottom and an output plug 12 at one end to output direct current to an electronic appliance. The cover 12 is secured on the base 11 and comprises a pair of openings 121 on respective sides, a recess 122 at one end and a hole 123 at the opposite end thereof. The lid 13 is secured on the cover 12 and covers the openings 121. The lid 13 comprises a hinge 132 at one end to be inserted into the hole 123, and a latch 131 at the opposite end of the hinge 132 to be secured to the recess 122.

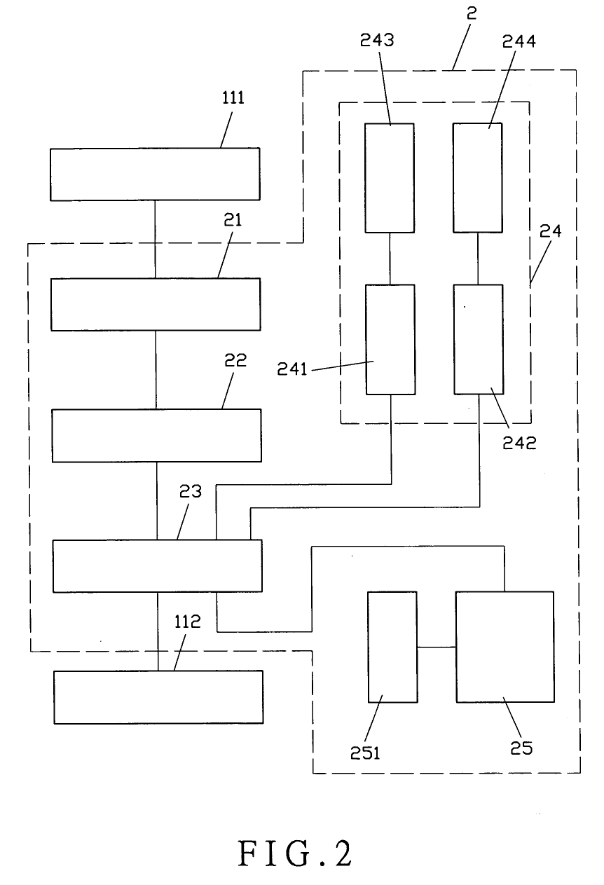

The switch circuitry 2, as shown in FIG. 2, comprises a rectifier protecting circuit 21, a voltage transforming circuit 22, an output rectifier circuit 23, an output control circuit 24, and a light illumination circuit 25. The rectifier protecting circuit 21 and the voltage transforming circuit 22 are connected to protect the entire circuit and to transform alternating current into direct current. The voltage transforming circuit 22 is to transform the home voltage (90˜264 volts) to the voltage as required.

The output rectifier circuit 23 is to stabilize output pulse wave. The output control circuitry 24 comprises a number of electric resistances with different values to form a voltage selection circuit 241 and a current selection circuit 242 with a pair of switches 243 and 244 to control the voltage selection circuit 241 and the current selection circuit 242, respectively. The switches 243 and 244 are used to adjust the values of the output voltage and the output current.

The light illumination circuit 25 comprises a pair of diodes 251 which shows different colors to identify the charging status of the battery.

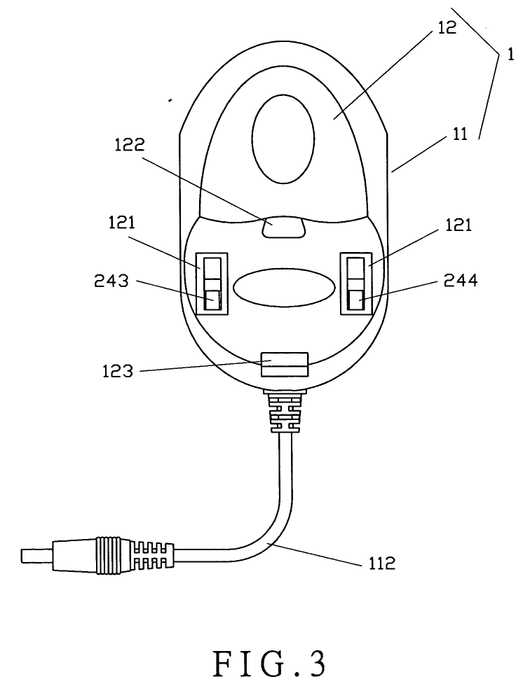

To assemble the present invention, as shown in FIG. 3, the switch circuitry 2 is deposited in the base 11 of the main body 1, and then the cover 12 is secured on the base 11. The two switches 243 and 244 of the switch circuitry 2 are exposed from the openings 121 of the cover 12. The lid 13 is secured on the cover 12 to conceal the switches 243 and 244.

To operate the present invention, a user may decide what voltage and current values their electronic appliance needs to adjust the switches 243 and 244 to vary the output voltage and current values as they need, and close the lid 13 to protect the switches 243 and 244 from being touched, accidentally.

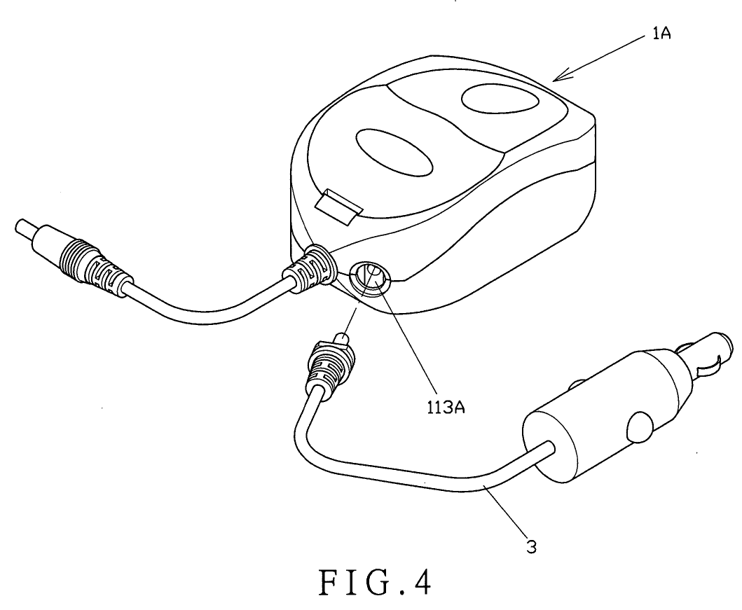

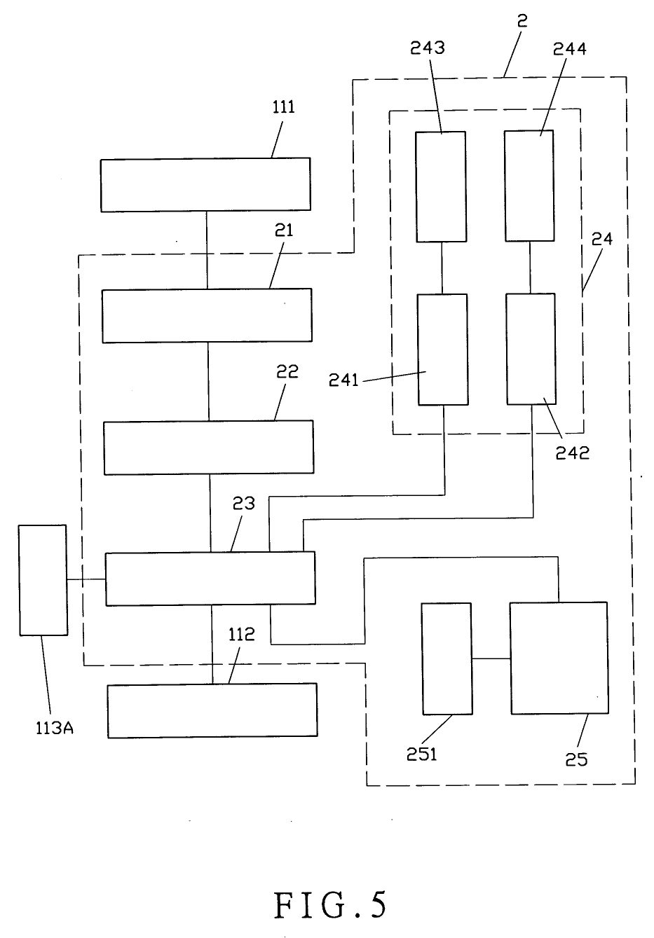

Further, this invention is able to transform alternating current and direct current to a desired value of direct current output, as shown in FIGS. 4 and 5. The switch circuitry 2 includes the rectifier protecting circuit 21, the voltage transforming circuit 22, the output rectifier circuit 23, the output control circuit 24, and the light illumination circuit 25. All of the circuits are functioned identical to the above-mentioned circuits. The output rectifier circuit 23 comprises a direct current point which is connected to a receptacle 113A of the base 11 of the main body 1 to be connected with a direct current plug 3 within a vehicle to charge battery. Thus, this invention is able to use both alternating and direct currents as power sources.

I claim:

1. A battery charger comprising a main body and a switch circuitry,
said switch circuitry being deposited in said main body and comprising a pair of switches exposed outwardly from said main body to adjust output values of voltage and current.

2. The battery charger, as recited in claim 1, wherein said main body comprises a lid thereon to cover said switches.

3. The battery charger, as recited in claim 1, wherein said main body comprises a base, a cover and a lid, said switch circuitry being deposited in said base, said base comprising a pair of plugs at a bottom portion and an output plug extending from one end, said cover being secured on said base and comprising a pair of openings on respective sides, a recess at one end, and a hole at an opposite end thereof, said lid being secured on said cover to cover said openings and comprising a latch and a hinge at respective ends to engage with said recess and said hole of said cover.

4. The battery charger, as recited in claim 1, wherein said switch circuitry includes an output control circuit, said output control circuit comprising a voltage selection circuit and a current selection circuit formed by resistances and said switches, said voltage selection circuit and said current selection circuit being conducted by said resistances through the control of said switches to vary the output values of voltage and current.

5. The battery charger, as recited in claim 4, wherein said switch circuitry comprises an output rectifier circuit having a direct current point for direct current input.
